(19) United States
(12) Patent Application Publication
(10) Pub. No.: US 2015/0373295 A1
(43) Pub. Date: Dec. 24, 2015

(54) APPARATUS AND METHOD FOR DEVICE CONFIGURATION

(71) Applicant: SAMSUNG ELECTRONICS CO., LTD., Suwon-si (KR)

(72) Inventor: Jan-David Stéphane OUTTERS, Ashford (GB)

(73) Assignee: SAMSUNG ELECTRONICS CO., LTD., Suwon-si (KR)

(21) Appl. No.: 14/664,273

(22) Filed: Mar. 20, 2015

(30) Foreign Application Priority Data
Jun. 24, 2014 (GB) 1411176.9
Oct. 14, 2014 (KR) 10-2014-0138602

(51) Int. Cl. H04N 5/44; H04N 21/4408; H04N 21/422; H04N 21/41

(52) U.S. Cl. CPC H04N 5/4403; H04N 21/4126; H04N 21/4408; H04N 21/42221; H04N 2005/4426; H04N 2005/4444

(57) ABSTRACT

A method of configuring one of a digital TV receiver and a mobile device comprises receiving profile information from one of the digital TV receiver and the mobile device, the profile information including one or more profile settings, and configuring the other one of the digital TV receiver and the mobile device based on the received profile information including the one or more profile settings. The profile settings may, for example, include one or more of: a current location; a country setting; a language setting; network configuration settings; accessibility settings; a list of installed applications; a list of favorite websites; and user account settings. The configuration may be performed during an installation procedure of one of the devices, and events relating to the installation procedure, such as progress notifications and audio/video tutorials, may be triggered at the other device.

### CROSS-REFERENCE TO RELATED APPLICATIONS

This application claims priority from Korean Patent Application No. 10-2014-0138602, filed on Oct. 14, 2014, in the Korean Intellectual Property Office, and U.K. Patent Application No. GB1411176.9, filed on Jun. 24, 2014, in the United Kingdom Intellectual Property Office, the disclosures of which are incorporated herein by reference in their entireties.

### BACKGROUND

1. Field

The present disclosure relates to an apparatus and method for configuring a device. More particularly, but not exclusively, the present disclosure relates to configuring a digital television (TV) receiver or a mobile device during an installation procedure.

2. Description of the Related Art

The installation of a TV receiver is often associated with a number of questions and parameters to be set by the user, including country, language, location, and accessibility preferences, as a few examples. As more functionality is added, the installation procedure becomes even more complex, and less user friendly. As an example, many digital TV receivers have the ability to connect to a home network, but currently the network configuration may be performed manually, often at the end of the installation procedure. Also, many new TV receivers include an application portal which may be installed with a default population of applications. However, users must manually enter their individual account settings for different applications, further complicating the installation procedure. The disclosure is made in this context.

### SUMMARY

According to a first aspect of the disclosure, a method of configuring one of a digital TV receiver and a mobile device comprises: receiving profile information from one of the digital TV receiver and the mobile device, the profile information including one or more profile settings; and configuring the one of the digital TV receiver and the mobile device based on the received profile information including the one or more profile settings.

The method may further comprise, prior to receiving the profile information: establishing a communication link between the digital TV receiver and the mobile device; and exchanging an encryption key between the digital TV receiver and the mobile device over the communication link. The profile information may be protected using the encryption key. The communication link may, for example, be a near-field communication (NFC) link. After exchanging the encryption key over the NFC link, the encrypted profile information may be received via a different communication link.

The profile information may be received during an installation procedure of the one of the digital TV receiver and the mobile device, and the method may further comprise transmitting a message from the one of the digital TV receiver and the mobile device to the other one of the digital TV receiver and the mobile device, to trigger an event relating to the installation procedure at the other one of the digital TV receiver and the mobile device. The event relating to the installation procedure may comprise reproducing an audio and/or video clip relating to the installation procedure, at the other one of the digital TV receiver and the mobile device.

The method may further comprise transmitting a signal from the one of the digital TV receiver and the mobile device to request the profile information, prior to receiving the profile information. The transmitted signal may include an authentication code for identifying the one of the digital TV receiver and the mobile device.

The digital TV receiver may receive the profile information from the mobile device, the received profile information may include location information relating to a location of the mobile device, and configuring the digital TV receiver may comprise setting a current location of the digital TV receiver according to the location information.

The method may further comprise: transmitting a request for a service list to a server, the service list comprising a list of services expected to be receivable by a receiver in one of a plurality of receiver groups; and receiving the service list from the server, wherein the request includes information identifying a current location of the digital TV receiver, and/or a reception medium through which the digital TV receiver is configured to receive services, and/or a service provider from which the digital TV receiver is configured to receive services.

The method may further comprise: selecting one or more services from the received service list; for each selected service, tuning to an expected frequency of the selected service to determine whether the selected service is receivable at the expected frequency; and in response to a determination that the selected one or more services are receivable at the expected frequencies, storing the received service list at the digital TV receiver.

The method may further comprise transmitting, to a server, information about services receivable by the digital TV receiver, and information identifying a current location of the digital TV receiver, and/or a reception medium through which the digital TV receiver is configured to receive services, and/or a service provider from which the digital TV receiver is configured to receive services.

The profile settings may include one or more of: a current location; a country setting; a language setting; network configuration settings; accessibility settings; a list of installed applications; a list of favorite websites; and user account settings.

The mobile device may, for example, be a mobile telephone, a tablet computer, a laptop computer, digital camera or wearable device.

According to a second aspect of the disclosure, a method of providing profile settings to one of a digital TV receiver and a mobile device comprises: retrieving one or more profile settings of the other one of the digital TV receiver and the mobile device; generating profile information including the one or more retrieved profile settings; and transmitting the profile information to the one of the digital TV receiver and the mobile device.

The method may further comprise: establishing a communication link between the digital TV receiver and the mobile device; and exchanging an encryption key between the digital TV receiver and the mobile device over the communication link. The profile information may be protected using the encryption key. The communication link may, for example, be an NFC link. After exchanging the encryption key over the NFC link, the encrypted profile information may be transmitted via a different communication link.

The profile information may be transmitted during an installation procedure of the one of the digital TV receiver and the mobile device, and the method may further comprise receiving a message from the one of the digital TV receiver and the mobile device to the other one of the digital TV receiver and the mobile device, to trigger an event relating to the installation procedure at the other one of the digital TV receiver and the mobile device. The event relating to the installation procedure may comprise reproducing an audio and/or video clip relating to the installation procedure, at the other one of the digital TV receiver and the mobile device.

The method may further comprise, prior to transmitting the profile information: receiving a signal from the one of the digital TV receiver and the mobile device, the signal including an authentication code for identifying the one of the digital TV receiver and the mobile device; and authenticating the one of the digital TV receiver and the mobile device using the authentication code. The profile information may only be transmitted if the authentication is successful.

The method may further comprise: receiving service identification information from the digital TV receiver, at the mobile device, the service identification information identifying a service receivable by the digital TV receiver; obtaining an application corresponding to the service identified by the service identification information, at the mobile device; and installing the obtained application at the mobile device.

Obtaining the application corresponding to the service may comprises: searching among a plurality of applications each associated with at least one of an application name, package name, and website; and in response to a match between the service identification information and one of the application names, package names, or websites, obtaining one of the plurality of applications associated with the matched application name, package name, or website.

According to a third aspect of the disclosure, there is provided a control method of a server configured to access a plurality of stored service lists corresponding to a plurality of receiver groups, each service list comprising a list of services expected to be receivable by a receiver in one of the plurality of receiver groups, the method comprising: receiving information about services receivable by the digital TV receiver, and information identifying a current location of the digital TV receiver, and/or a reception medium through which the digital TV receiver is configured to receive services, and/or a service provider from which the digital TV receiver is configured to receive services; determining which one of the plurality of receiver groups the digital TV receiver belongs to, based on the information received from the digital TV receiver; and updating the stored service list for the receiver group to which the digital TV receiver belongs, based on the information about the services receivable by the digital TV receiver.

A computer-readable storage medium may store computer program instructions which, when executed by one or more processors, cause the one or more processors to perform any of the above-described methods.

According to a fourth aspect of the disclosure an apparatus for configuring one of a digital TV receiver and a mobile device comprises: a receiving unit arranged to receive profile information from the other one of the digital TV receiver and the mobile device, the profile information including one or more profile settings; and a configuration setting unit arranged to configure the one of the digital TV receiver and the mobile device based on the one or more profile settings included in the received profile information.

The apparatus may further comprise: a connection management unit arranged to establish a communication link between the digital TV receiver and the mobile device; and a key management unit arranged to exchange an encryption key between the digital TV receiver and the mobile device over the communication link, wherein the profile information may be protected using the encryption key. The connection management unit may be arranged to establish an NFC link. After the encryption key is exchanged over the NFC link, the receiving unit may be arranged to receive the encrypted profile information is received via a different communication link.

The profile information may be received during an installation procedure of the one of the digital TV receiver and the mobile device, and the apparatus may further comprise a transmitting unit arranged to transmit a message from the one of the digital TV receiver and the mobile device to the other one of the digital TV receiver and the mobile device, to trigger an event relating to the installation procedure at the other one of the digital TV receiver and the mobile device. The event relating to the installation procedure may comprise reproducing an audio and/or video clip relating to the installation procedure, at the other one of the digital TV receiver and the mobile device.

The apparatus may further comprise a transmitting unit arranged to transmit a signal from the one of the digital TV receiver and the mobile device to request the profile information, the signal including an authentication code for identifying the one of the digital TV receiver and the mobile device.

The configuration setting unit may be arranged to configure the digital TV receiver and the receiving unit is arranged to receive the profile information from the mobile device, the received profile information may include location information relating to a location of the mobile device, and the configuration setting unit may be arranged to set a current location of the digital TV receiver according to the location information.

The apparatus may further comprise: a service list management unit arranged to transmit a request for a service list to a server and receive the service list from the server, the service list comprising a list of services expected to be receivable by a receiver in one of a plurality of receiver groups, wherein the request includes information identifying a current location of the digital TV receiver, and/or a reception medium through which the digital TV receiver is configured to receive services, and/or a service provider from which the digital TV receiver is configured to receive services.

The apparatus may further comprise: a tuner for tuning to a frequency to receive a service, wherein the service list management unit may be further arranged to select one or more services from the received service list, and for each selected service, control the tuner to tune to an expected frequency of the selected service to determine whether the selected service is receivable at the expected frequency. The service list management unit may also be arranged to store the received service list at the digital TV receiver, in response to a determination that the selected one or more services are receivable at the expected frequencies.

The apparatus may further comprise a transmitting unit arranged to transmit, to a server, information about services receivable by the digital TV receiver, and information identifying a current location of the digital TV receiver, and/or a reception medium through which the digital TV receiver is configured to receive services, and/or a service provider from which the digital TV receiver is configured to receive services.

The profile settings may include one or more of: a current location; a country setting; a language setting; network configuration settings; accessibility settings; a list of installed applications; a list of favorite websites; and user account settings.

The mobile device may, for example, be a mobile telephone, a tablet computer, a laptop computer, digital camera or wearable device.

According to a fifth aspect of the disclosure, there is provided an apparatus for providing profile settings to one of a digital TV receiver and a mobile device, the apparatus comprising: a profile information generator arranged to retrieve one or more profile settings of the other one of the digital TV receiver and the mobile device, and generate profile information including the one or more retrieved profile settings; and a transmitting unit arranged to transmit the profile information to the one of the digital TV receiver and the mobile device.

The apparatus may further comprise: a connection management unit arranged to establish a communication link between the digital TV receiver and the mobile device; and a key management unit arranged to exchange an encryption key between the digital TV receiver and the mobile device over the communication link, wherein the profile information may be protected using the encryption key. The connection management unit may be arranged to establish an NFC link. After the encryption key is exchanged over the NFC link, the transmitting unit may be arranged to transmit the encrypted profile information via a different communication link.

The profile information may be transmitted during an installation procedure of the one of the digital TV receiver and the mobile device, and the apparatus may further comprise a receiving unit arranged to receive a message from the one of the digital TV receiver and the mobile device to the other one of the digital TV receiver and the mobile device, to trigger an event relating to the installation procedure at the other one of the digital TV receiver and the mobile device. The event relating to the installation procedure may comprise reproducing an audio and/or video clip relating to the installation procedure, at the other one of the digital TV receiver and the mobile device.

The apparatus may further comprise: a receiving unit arranged to receive a signal from the one of the digital TV receiver and the mobile device, the signal including an authentication code for identifying the one of the digital TV receiver and the mobile device; and an authentication unit arranged to authenticate the one of the digital TV receiver and the mobile device using the authentication code. The apparatus may be arranged to only transmit the profile information if the authentication is successful.

The apparatus may further comprise an application management unit arranged to receive service identification information from the digital TV receiver, the service identification information identifying a service receivable by the digital TV receiver, obtain an application corresponding to the service identified by the service identification information, and install the obtained application.

The application management unit may be arranged to obtain the application corresponding to the service by searching among a plurality of applications each associated with at least one of an application name, package name, and website, and in response to a match between the service identification information and one of the application names, package names, or websites, obtain one of the plurality of applications associated with the matched application name, package name, or website.

According to a sixth aspect of the disclosure, there is provided a server comprising: a storage access unit arranged to access a plurality of stored service lists corresponding to a plurality of receiver groups, each service list comprising a list of services expected to be receivable by a receiver in one of the plurality of receiver groups; a network interface for communicating with a digital TV receiver, the server being arranged to receive, via the network interface, information about services receivable by the digital TV receiver and information identifying a current location of the digital TV receiver, and/or a reception medium through which the digital TV receiver is configured to receive services, and/or a service provider from which the digital TV receiver is configured to receive services; and a service list management unit arranged to determine which one of the plurality of receiver groups the digital TV receiver belongs to, based on the information received from the digital TV receiver, and to control the storage access unit to update the stored service list for the receiver group to which the digital TV receiver belongs, based on the information about the services receivable by the digital TV receiver.

### BRIEF DESCRIPTION OF THE DRAWINGS

Embodiments of the present disclosure will now be described, by way of example only, with reference to the accompanying drawings, in which:

FIG. 1 illustrates a system for configuring a digital television (DTV), according to an embodiment of the present disclosure;

FIG. 2 is a flowchart illustrating a method of configuring the DTV of FIG. 1, according to an embodiment of the present disclosure;

FIG. 3 is a flowchart illustrating a method of sharing profile information between devices using a secure connection, according to an embodiment of the present disclosure;

FIG. 4 is a flowchart illustrating a method of obtaining a service list during an installation procedure of a digital TV receiver, according to an embodiment of the present disclosure;

FIG. 5 is a flowchart illustrating a method of updating a service list at a server, according to an embodiment of the present disclosure;

FIG. 6 is a flowchart illustrating a method of authenticating a device during an installation procedure, according to an embodiment of the present disclosure;

FIG. 7 is a flowchart illustrating a method of populating a mobile device with applications related to broadcast services receivable by a digital TV receiver, according to an embodiment of the present disclosure;

FIG. 8 is a flowchart illustrating a method of providing an interactive installation procedure, according to an embodiment of the present disclosure;

FIG. 9 illustrates a system comprising a DTV and a mobile device, according to an embodiment of the present disclosure; and

FIG. 10 illustrates a server according to an embodiment of the present disclosure.

### DETAILED DESCRIPTION

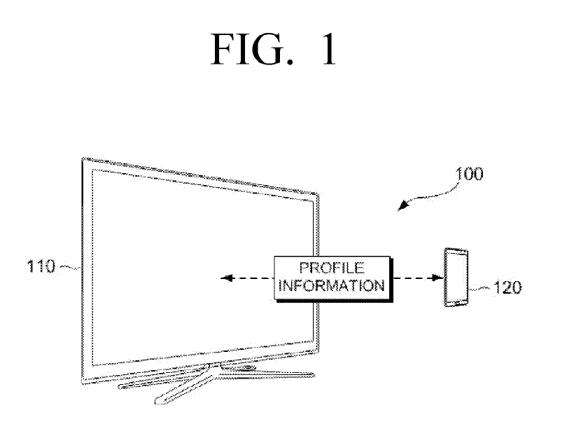

Referring to FIG. 1, a system for configuring a digital television (TV) receiver is illustrated according to an embodiment of the present disclosure. In the present embodiment the digital TV receiver is included in a digital television (DTV), but in other embodiments a similar approach may be used to configure a stand-alone digital TV receiver, for example a set-top box (STB) connectable to a separate display.

As shown in FIG. 1, the system 100 of the present embodiment comprises a digital television (DTV) 110 and a device such as a smart phone 120 or other mobile devices able to communicate with the DTV. During an installation procedure, which may also be referred to as a setup procedure or configuration procedure, the DTV 110 may receive profile information including one or more profile settings from the mobile device 120. The DTV 110 may be automatically configured based on the profile information received from the mobile device 120, reducing the need for user input and thereby providing a simplified installation procedure.

Although a mobile device 120 is used in the present embodiment, in other embodiments the profile settings may be received from any suitable mobile device, for example another type of mobile telephone handset other than a mobile device, or any other type of device such as a laptop computer, tablet computer, e-reader, personal digital assistant (PDA), wearable device or digital camera.

Furthermore, although in the present embodiment a digital TV receiver is configured based on profile information received from a mobile device, in other embodiments the process may be reversed so that a mobile device is configured based on profile information received from a digital TV receiver. Examples of methods that may be implemented by either the digital TV receiver or the mobile device will now be described in detail, to aid understanding of the present disclosure.

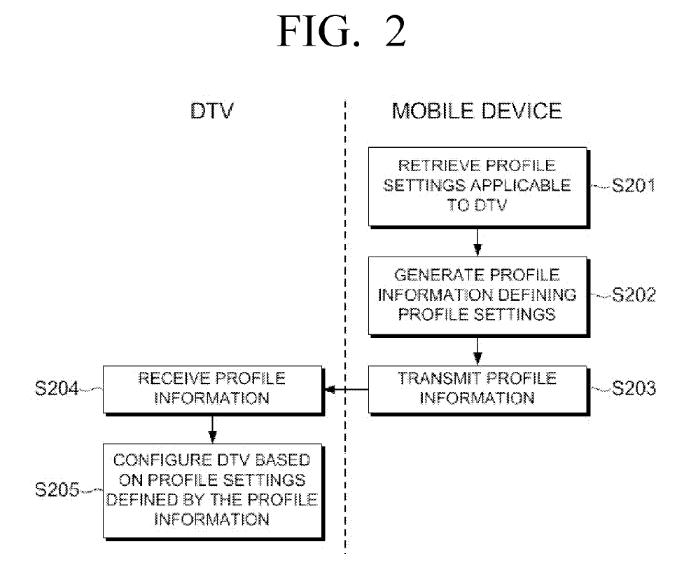

FIG. 2 illustrates a method of configuring the DTV of FIG. 1, according to an embodiment of the present disclosure. The flowchart in FIG. 2 shows which processes of the method are performed at the DTV, and which are performed at the mobile device. As mentioned above, in another embodiment the process may be reversed in order to configure the mobile device using settings from the DTV. That is, the method processes performed by the mobile device in FIG. 2 may instead be performed at the DTV, and the method processes performed by the DTV in FIG. 2 may instead be performed at the mobile device.

First, in process S201, the mobile device retrieves one or more profile settings. In most cases, the profile settings will be stored in internal memory, but in certain cases the profile settings could be downloaded or generated when required, for example when the profile settings include a current location of the mobile device.

Depending on the embodiment, process S201 may be initiated either by the DTV or by the mobile device. As an example, after placing the DTV into an installation mode, a user may launch a corresponding installation application at the mobile device, and the application may automatically retrieve the profile settings in process S201 after being launched. In this approach, process S201 is initiated by the mobile device. As another example, in some embodiments the DTV may scan for local devices after being placed into the installation mode, and upon finding the mobile device the DTV may transmit a request for profile settings. In this approach, process S201 is initiated by the DTV.

After retrieving the profile settings, then in process S202, the mobile device generates profile information including the profile settings. Preferably, the profile information is formatted according to an industry standard, to ensure that the profile settings may be understood by the DTV. If various possible formats are available, for example according to different versions of a standard, the DTV and mobile device may negotiate before sharing the profile settings to agree on a particular format for the profile information.

In process S203, the profile information is transmitted from the mobile device to the DTV, which receives the profile information in process S204. In an embodiment, the mobile device sends the profile information to the DTV over a wireless local area network (WLAN) interface, but in other embodiments the profile information may be sent over any type of interface. As an examples, in other embodiments the profile information may be transferred over wired or wireless interface such as a Bluetooth, Zigbee, Near-Field Communication (NFC), or Universal Serial Bus (USB) interface.

Next, in process S205, the DTV is configured based on the profile settings included in the received profile information, for example by updating local profile settings of the DTV to match the profile settings received from the mobile device.

The profile settings may include device profile settings relating to general device settings, and/or may include user profile settings relating to specific settings for an individual user profile. Examples of device profile settings that may be shared between devices in embodiments of the present disclosure include, but are not limited to: a current location; a country setting; a language setting; and network configuration settings. Examples of user profile settings that may be shared between devices in embodiments of the present disclosure include, but are not limited to: accessibility settings; a list of installed applications; a list of favorite websites; and user account settings, such as stored username/password information for websites and/or applications.

When network configuration settings are shared, the mobile device may be used to verify whether or not the DTV has successfully connected to a local network after sending the profile information. Specifically, after transmitting the profile information, the mobile device may be configured to periodically check whether a message has been received from the TV over the network, for example a Universal Plug and Play (UPnP) discovery message. The mobile device may confirm that the message has come from the DTV by comparing a device identification code included in the message to a known identification code of the DTV. Depending on the embodiment, the identification code could be pre-programmed into the mobile device, or could be received from the DTV. For example, in embodiments in which the DTV transmits a request for profile information to the mobile device, the DTV identification code may be included in the profile information request. When the mobile device receives the message from the DTV, the mobile device may be configured to notify the user that the DTV has successfully been configured for the local network. If a preset time period elapses without a discovery message being received, a time-out message may be displayed to notify the user that the DTV has not been able to connect to the network.

By sharing profile settings automatically between devices, the configuration procedure may be simplified since the user does not have to input every setting manually. Additionally, other advantages arise when particular types of information are shared, as will become apparent from the following description of specific embodiments.

For example, the shared profile settings may include location information. The location information may take various forms, including but not limited to Global Positioning System (GPS) coordinates or other navigation system coordinates, a postcode or zip code, town/city name, or country. After receiving the location information, the receiving device (the DTV in FIGS. 1 and 2) may set its current location based on the received location information. In some embodiments, when location information is shared, the DTV may then activate a respective pre-programmed local profile for the current region or country in which the DTV is located, thereby further streamlining the configuration procedure.

As another example, the shared profile settings may include a list of applications installed on the mobile device. The digital TV receiver may be arranged to download and install applications matching those installed on the mobile device, for example by searching an app store website for an application with the same name as one installed on the mobile device. This allows the digital TV receiver to be automatically populated with the user's preferred applications.

As yet another example, the digital TV receiver may be arranged to personalize a TV guide according to the received profile information. For instance, the received profile information may include demographic information such as the gender and age of the user, and the TV guide may be personalized by recommending content that is expected to be of interest to the user based on demographic profiling. As another example, the profile information may include accessibility and/or language settings used in the mobile device, and the TV guide may be personalized using the same accessibility and/or language settings.

In the method of FIG. 2, the initial pairing is performed via an NFC link. In another embodiment, instead of using NFC, the devices could be paired using a different method, for example, by displaying a Quick Response (QR) code on the DTV screen. The QR code may include an encryption key, and may be scanned using a QR reader application on the mobile device. The mobile device may then use the encryption key to communicate securely with the DTV over a network connection, for example a WLAN connection.

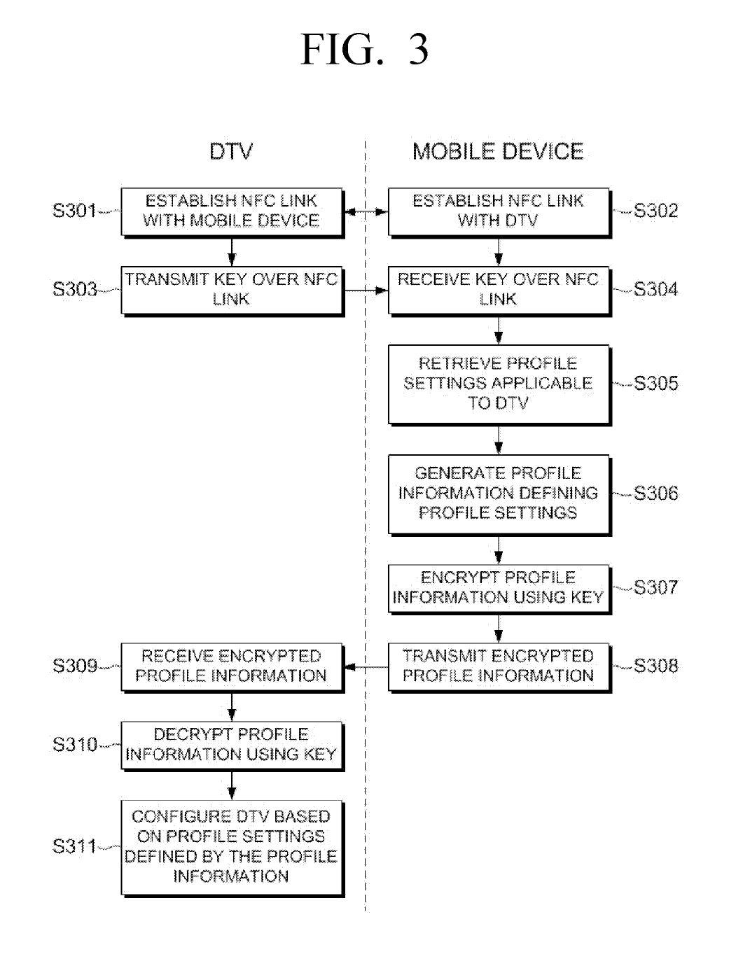

Referring to FIG. 3, a method of sharing profile information between devices using a secure connection is illustrated, according to an embodiment of the present disclosure. The method may be used in a system such as the one shown in FIG. 1, to send profile information from a mobile device to a DTV, or may be used to share profile information between any other type of digital TV receiver and mobile device. In the present embodiment the method uses an NFC link to exchange an encryption key between the DTV and mobile device, but in other embodiments a different type of communication link could be used instead of NFC.

First, in processes S301 and S302, an NFC link is established between the DTV and the mobile device. Methods of establishing an NFC link between devices are well known, and a detailed description will not be provided here. In the present embodiment, the DTV is placed into an installation mode before process S301, and begins broadcasting an invitation via NFC to other devices in the immediate vicinity. At the same time, a corresponding installation application is launched on the mobile device. The application on the mobile device detects the invitation being broadcasted by the DTV, and responds by launching an NFC application to establish the connection in process S302.

Once the NFC link is established, in process S303, the DTV transmits an initial encryption key over the NFC link to the mobile device, which receives the encryption key in process S304. Because NFC is limited to very short-range transmission, unauthorized third parties are prevented from eavesdropping and intercepting the encryption key. The use of an NFC link thereby ensures that the encryption key remains private between the devices.

Once the devices have exchanged the encryption key, the DTV and mobile device are paired and may share profile information securely over any connection using the encryption key.

Specifically, in processes S305 and S306, the mobile device retrieves profile settings and generates profile information, as in processes S201 and S202 of FIG. 2. Then, in process S307, the mobile device protects the profile information using the encryption key. In the present embodiment the profile information is protected using encryption, to ensure that an unauthorized third party may not intercept and access the profile settings, which may include personal user account information. In other embodiments, the profile information may be protected using authentication instead of or in addition to encryption, to verify that the received profile information has come from the paired mobile device as opposed to an unauthorized third party.

Next, in process S308, the protected profile information is transmitted to the DTV, which receives the protected profile information in process S309. In processes S308 and S309, the profile information may be sent over a different connection than the NFC link used in processes S303 and S304. For example, as described above with reference to FIG. 2, the profile information could be transferred over any other suitable interface, such as WLAN, Bluetooth, Zigbee, or a Universal Serial Bus (USB).

Then, in process S310, the DTV decrypts the received profile information using the encryption key that was previously shared in processes S303 and S304. Finally, in process S311, the DTV is configured based on the profile settings included in the profile information, as in process S205 of FIG. 2.

In of FIG. 3 the encryption key is provided by the device to be configured, which in the present example is a DTV. However, in other embodiments the encryption key may be provided by the same device that provides the profile settings, which in the present example is the mobile device. Therefore in some embodiments the key will be sent in the opposite direction to that shown in processes S303 and S304, when the key is exchanged between the devices.

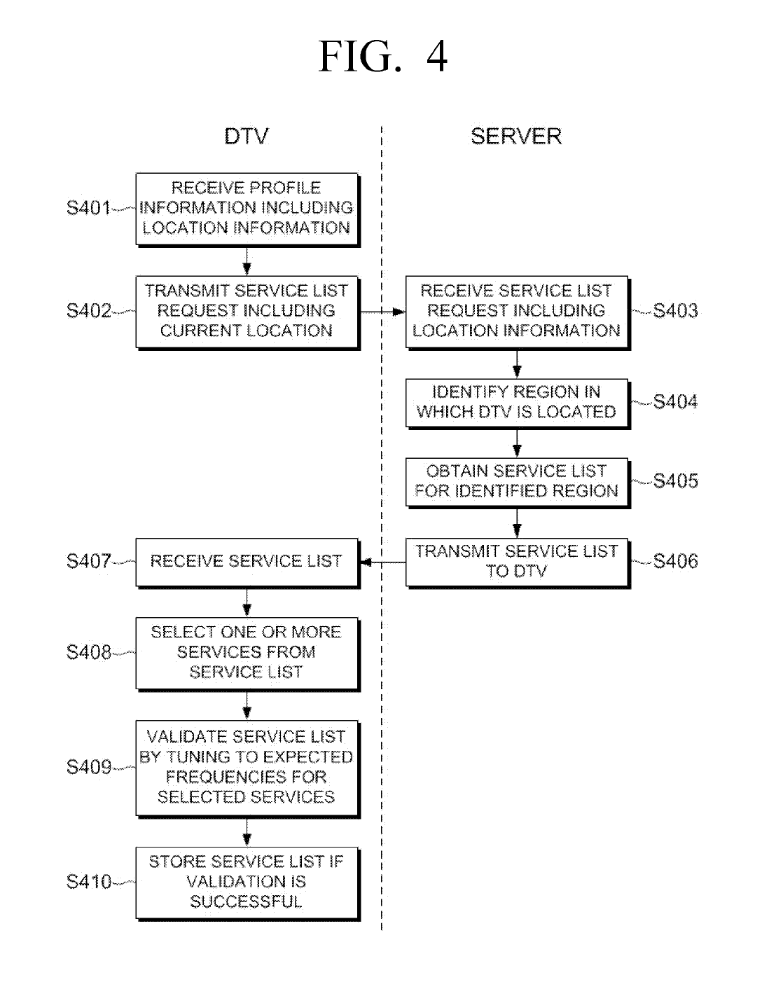

Referring to FIG. 4, a method of obtaining a service list during an installation procedure of a digital TV receiver is illustrated, according to an embodiment of the present disclosure. The method may be performed when the digital TV receiver receives location information from another device, and requires the digital TV receiver to be able to communicate with a server. The method allows the digital TV receiver to quickly obtain a list of services that are expected to be receivable, without having to perform a length channel scanning operation to search for all available services. The method also allows the digital TV received to quickly obtain a list of services related to or associated with the location information based on the location information received from another device.

First, in process S401, the digital TV receiver, which in the present embodiment is included in a DTV, receives profile information from a mobile device as described above. The received profile information includes location information relating to a location of the mobile device, and after receiving the location information, the DTV is configured by setting the current location according to the location defined by the location information. Therefore by process S402 in FIG. 4, the current location of the DTV has been set using the location of the mobile device from which the profile information was received.

In process S402, the DTV transmits a request for a service list to a server, which receives the request in process S403. The request includes information identifying the current location. The server is arranged to access a plurality of stored service lists corresponding to a plurality of receiver groups. The geographical areas may be defined in various ways in different embodiments, for example, using GPS coordinates or postal addresses. Each service list comprises a list of services that are expected to be receivable in the corresponding geographical area. The service list includes a service identifier for each service, and tuning parameters for the service (e.g. a broadcast frequency). The list may optionally include a Receiver Channel Number (RCN) for the service, which may be the Receiver Channel Number most commonly assigned to that service by receivers in that geographical area. The server may generate and update the service list for each geographical area based on reports from digital TV receivers located within that area about the services that are able to be received.

In the present embodiment, each of the receiver groups corresponds to a geographical area. However, in other embodiments, the receiver groups may be defined in various ways. Different receiver groups may be defined for different locations, and/or for different reception mediums (e.g. cable, satellite, IPTV, terrestrial), and/or for different service providers. For example, within the same geographical area, separate receiver groups may be defined for different reception mediums. Similarly, for each reception medium, different receiver groups may be defined depending on the service provider. For example, different cable TV providers may offer different selections of broadcast services. Depending on how the receiver groups are defined in any given embodiment, the request transmitted by the digital TV receiver may identify the current location of the receiver, and/or the current reception medium, and/or the service provider from which the receiver is configured to receive services.

In process S404, the server uses the received location information to identify the geographical area in which the DTV is currently located. After identifying the geographical area, the server retrieves the stored service list for the identified geographical area in process S405, and transmits the service list to the DTV in process S406.

After receiving the service list in process S407, the DTV proceeds to validate the received service list in order to determine whether the service list may be used. In detail, in process S408, the DTV selects a subset of one or more services from the received service list. Here, the DTV may select a fixed number of services, or may select a variable number of services depending on the size of the received services list, for example by selecting every tenth service from the list. Then, in process S409, for each selected service the DTV tunes to an expected frequency of the selected service, which is the frequency identified in the service list, to determine whether the selected service is receivable at the expected frequency. Because only a subset of the services are selected in process S408, the time taken to validate the selected services in process S409, may be substantially reduced in comparison to the time that would be required to perform a full channel scanning operation.

Finally, in process S410, the received service list is stored and used in response to a determination that the selected one or more services are receivable at the expected frequencies. If any of the selected services are not detected at the corresponding frequency indicated by the service list, it is determined that the service list is invalid, and the digital TV receiver may instead perform a normal channel scanning operation as part of the installation procedure, to build its own service list.

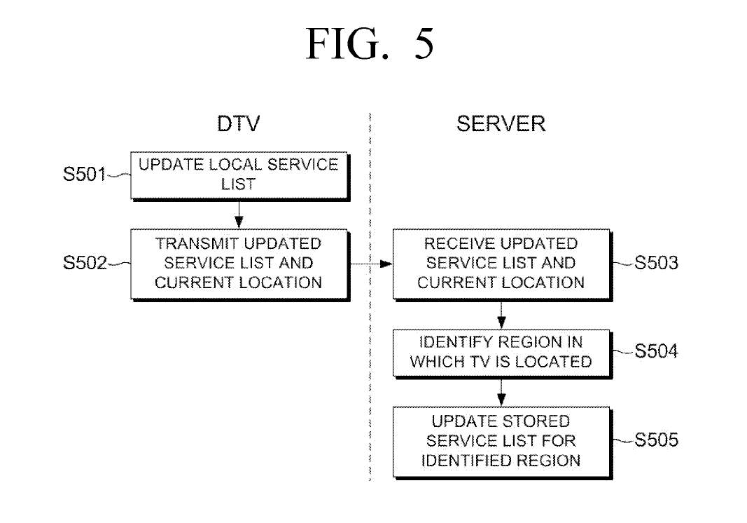

Referring now to FIG. 5, a method of updating a service list at a server is illustrated, according to an embodiment of the present disclosure. The method may be performed at the server described above with reference to FIG. 4, to maintain the database of service lists for different geographical areas.

First, in process S501, the DTV updates the local service list, for example by performing a channel scanning operation to search for currently receivable broadcast services. The service list could be updated during an installation procedure, or during normal operation of the receiver. For example, the DTV may be configured to update the local service list at regular intervals.

Next, in process S502, the DTV transmits information about the current location and the updated service list to the server, which receives the information in process S503. Depending on the embodiment, the DTV may attempt to upload the updated service list at regular intervals, and/or in response to a specific event such as a channel scanning operation.

After receiving the information, in process S504, the server determines which geographical area the DTV is located in, based on the current location of the DTV. Then, in process S505, the server updates the stored service list for the geographical area in which the DTV is located, based on the information about the services receivable by the DTV at the current location.

Regularly updating the service lists maintained by the server, using a method as shown in FIG. 5, ensures that the information in each service list accurately reflects the services that are currently available in each region. This improves the chances of a service list successfully validating during an installation procedure, as described above with reference to processes S408 to S410 of FIG. 4. Preferably, if validation of a service list fails in process S409 of FIG. 4, then the digital TV receiver is configured to automatically update the service list itself and upload the updated service list to the server using the method of FIG. 5, ensuring that the service list maintained by the server is kept up-to-date.

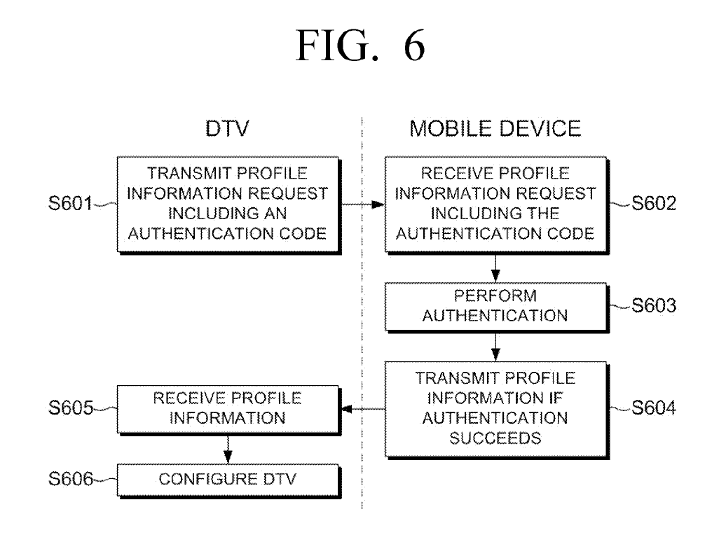

Referring now to FIG. 6, a method of authenticating a device during an installation procedure is illustrated, according to an embodiment of the present disclosure.

First, in process S601, the DTV transmits a request for profile information. In the present embodiment, the DTV is configured to regularly broadcast the request via NFC after starting the installation procedure, to search for local devices that may provide the profile information. The request includes an authentication code to identify the DTV.

The profile information request is received by the mobile device in process S602. Next, in process S603, the mobile device attempts to authenticate the request, by using an authentication algorithm to verify whether the received authentication code is genuine. In process S604, the mobile device only transmits the profile information to the DTV if the authentication is successful. If authentication fails, the profile information is not transmitted.

In process S605, the DTV receives the profile information, as in process S204 of FIG. 2, and in process S606, the DTV is configured based on the received profile information, as in process S205 of FIG. 2.

By using authentication to verify the identity of the device requesting the profile information, it is ensured that any sensitive user data included in the profile settings will only be shared with the genuine DTV, and not with any unauthorized devices.

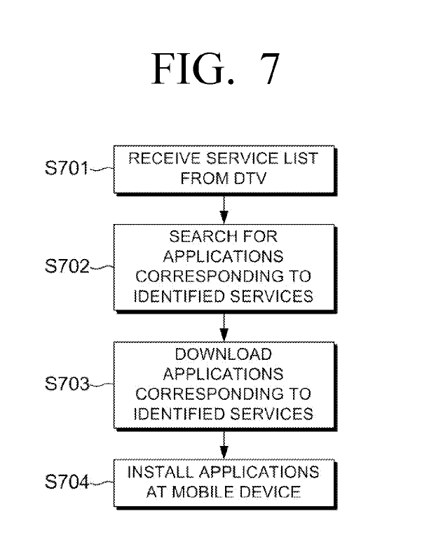

Referring now to FIG. 7, a method of populating a mobile device with applications related to broadcast services receivable by a digital TV receiver is illustrated, according to an embodiment of the present disclosure. The method may be performed by a mobile device after pairing with a digital TV receiver, as described above, in order to locate and install applications relating to currently receivable broadcast services. An example of an application relating to a broadcast service is a mobile TV broadcasting application viewing content from the broadcast service, either by streaming live programs or downloading content on demand.

First, in process S701, the mobile device receives service identification information from the digital TV receiver. The service identification information identifies one or more service receivable by the digital TV receiver. The service identification information may simply be the service list currently in use at the receiver. In some embodiments, rather than transmitting the entire service list including tuning parameters for each service, the digital TV receiver may extract and transmit only the service names of all services from the service list.

In some embodiments, if the mobile device has previously received a service list from another digital TV receiver in the same geographical area, the mobile device may be arranged to reuse the previously-received service list instead of obtaining a new service list from the current digital TV receiver. This may reduce the time taken to complete the installation procedure, as it will typically be quicker to retrieve the existing service list from internal memory than to request and receive a new service list from the digital TV receiver, since the time taken to receive the service list will be limited by the bandwidth of the connection between the digital TV receiver and the mobile device.

Then, in process S702, the mobile device searches among a plurality of applications, for example by querying an online application store. In an embodiment, each application is associated with a number of fields including at least one of an Application Name, Package Name, and Associated Website. The mobile device performs a text search among the Application Name, Package Name and Associate Website using the service name of each service.

When an application matching one of the services is found, the application may be automatically downloaded in S703. Alternatively, user confirmation may be requested before downloading the application. If more than one application is found with a match to the service name, the applications may be ranked according to the fields in which a match was found. In an embodiment, for example, the following ranking order is used, with (1) representing the highest ranking and (5) representing the lowest ranking:
(1) Match found in each of Application Name, Package Name and Associated Website;
(2) Match only found in Application Name;
(3) Match only found in Package Name and Associated Website;
(4) Match only found in Package Name;
(5) Match only found in Associated Website.

The applications may be ranked and displayed in order, for a user to select which application to download.

Then, after obtaining the applications, in process S704, the applications are installed at the mobile device.

In the above-described embodiment, associated applications are obtained by performing a text search among the Application Name, Package Name, and Associated Website for each one of a plurality of applications. In other embodiments, a different approach may be used to find and obtain associated applications. For example, in some embodiments, a server may host a database in which each service is directly associated with one or more application identifiers. The mobile device could then query the server to retrieve the application identifiers associated with a particular service, and download the applications from another source such as an online application store, or could receive the applications directly from the server.

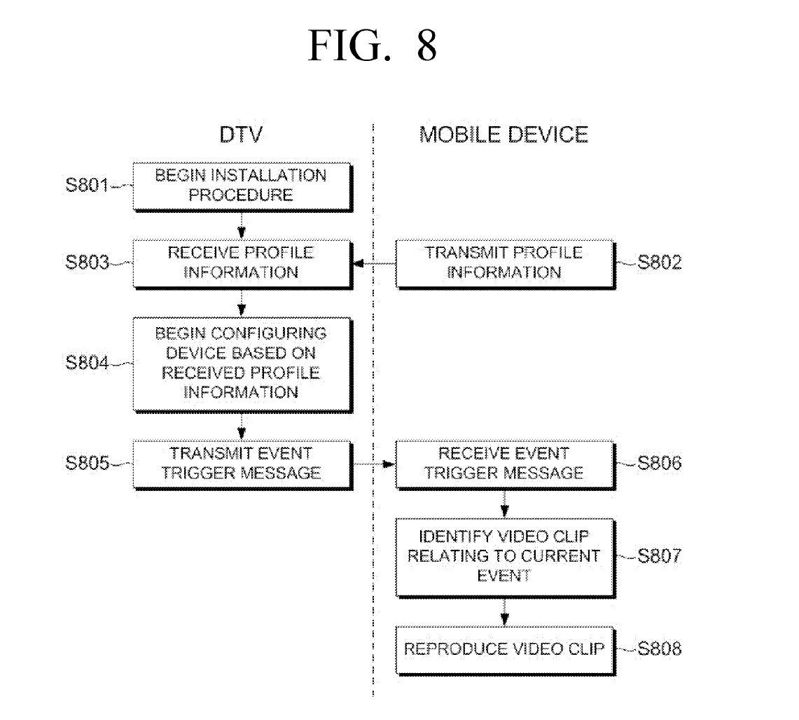

Referring now to FIG. 8, a method of providing an interactive installation procedure is illustrated, according to an embodiment of the present disclosure. The method may be used in conjunction with any of the above-described methods relating to sharing profile information between devices.

The method of FIG. 8 allows a user to enjoy additional interactivity during an installation procedure of one of the devices, by triggering associated events at the other device. Examples of events that may be triggered include progress notifications to inform the user of the current progress of the installation procedure, and audio/video tutorials relating to the installation procedure. The ability to trigger events at another device during the installation procedure may be particularly useful when the devices have different user interface capabilities, especially in situations where the user has a visual or hearing impairment.

In the present embodiment, events are triggered at a mobile device in order to add interactivity to an installation procedure of a digital TV receiver, which in the present embodiment is a DTV. In other embodiments, the direction may be reversed so that events are triggered at a digital TV receiver during the installation procedure of a mobile device.

First, in process S801, an installation procedure is initiated at the DTV. The DTV may automatically enter the installation procedure when it is turned on for the first time, or a user may manually select the installation procedure after moving the DTV to a new location, for example to connect to a new network and/or to search for new broadcast services.

After starting the installation procedure, the mobile device transmits profile information in process S802, which is received by the DTV in process S803. The profile information may be shared using any of the methods described herein. After profile information has been received, in process S804, the installation procedure begins configuring the DTV based on the received profile settings.

While the installation procedure continues, in process S805, the DTV automatically transmits a message to the mobile device to trigger an event relating to the installation procedure at the mobile device. The message may be referred to as an event trigger message, and may be transmitted at certain pre-programmed points during the installation procedure. The mobile device receives the message in process S806.

In the present embodiment, the event trigger message includes an event type identifier, which signals the type of event to which the message relates. The event type identifier may take various formats. In the present example, the event type identifier comprises 8 bits denoting the type of event. Examples of different types of event and their associated hexadecimal values are as follows:

0x00 profile settings successfully received and imported

0x01 channel scan completed

0x02 no signal found

0x03 launch an application at the mobile device

0x04 open a url in a web browser application at the mobile device

0x05 first signals found

These event types and values are merely exemplary, and other event types may be defined in other embodiments.

In the present embodiment, an application running on the mobile device is pre-programmed with different audio and/or video clips to be reproduced at certain stages during the installation procedure. When an event trigger message is received which indicates that one of the certain stages has been reached, in process S807, the mobile device identifies the clip relating to the current event, and reproduces the clip in S808.

In certain embodiments, the mobile device may connect to the Internet to search for content such as audio or video clips or webpages, to be retrieved and reproduced in response to a particular event type being signaled.

In the embodiment of FIG. 8, events are triggered during in installation procedure. In other embodiments of the disclosure, a similar method may also be used to trigger events at any time during normal operation. Examples of events that may be triggered after include an event to notify the user of the service currently being received at the DTV, or to notify the user that an updated service list is available.

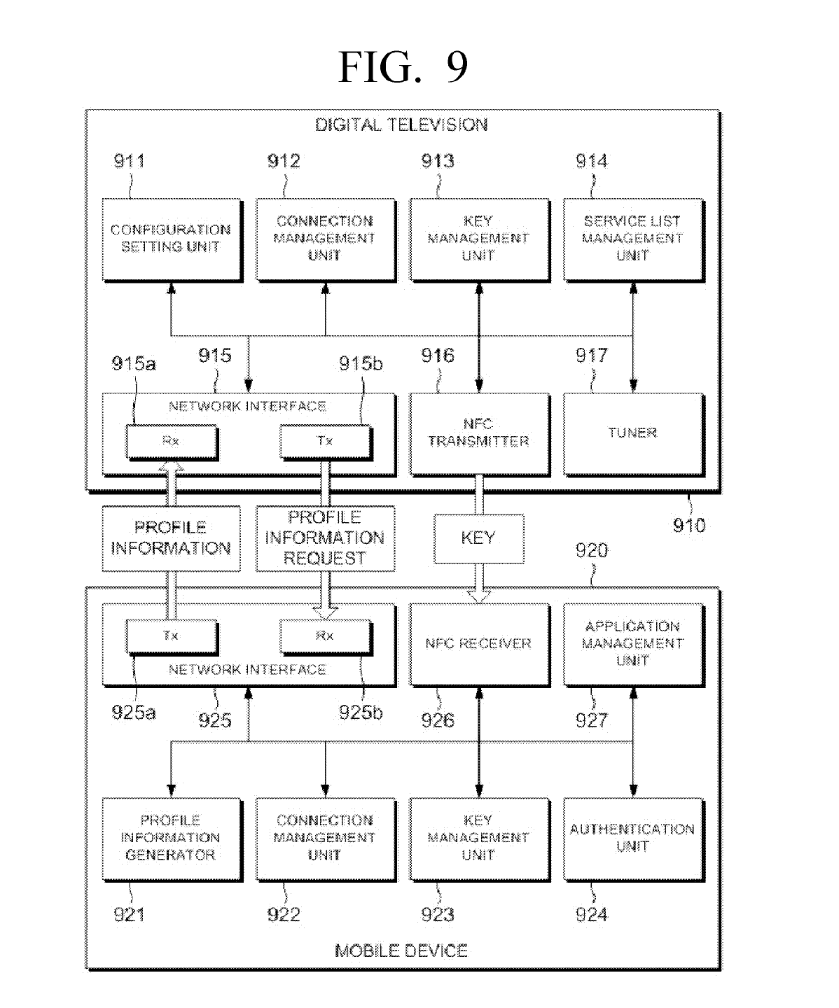

Referring now to FIG. 9, a system comprising a DTV and a mobile device is illustrated, according to an embodiment of the present disclosure. The system may perform any of the methods disclosed herein, to configure the DTV using profile settings from the mobile device. In other embodiments, the elements shown in either device in FIG. 9 may be included in the other device, to allow the procedure to be performed in reverse, that is, to configure the mobile device using profile settings from the DTV. In other embodiments certain elements shown in FIG. 9 may be omitted, depending on the functionality required. For example, if encryption and authentication are not required, the key management units or key managers 913, 923, authentication unit or authenticator 924, NFC transmitter 916 and NFC receiver 926 could be omitted.

One or more elements in FIG. 9 may be implemented using dedicated hardware, or using software instructions executed on one or more processors. The software instructions may be stored in any suitable non-transitory computer-readable storage medium. In some embodiments, individual elements in FIG. 9 may be implemented using a combination of hardware and software.

The DTV 910 of FIG. 9 includes apparatus comprising a configuration setting unit 911, a connection management unit 912, a key management unit 913, a service list management unit 914, a network interface 915, a NFC transmitter 916, and a tuner 917.

The network interface 915 includes a transmitting unit 915b arranged to transmit a signal to the mobile device 920 to request profile information. In an embodiment, authentication is used and the request includes an authentication code to identify the DTV 910. The network interface 915 also includes a receiving unit 915a arranged to receive profile information from the mobile device 920, using any of the methods disclosed herein. The configuration setting unit 911 is arranged to configure the DTV 910 based on the profile settings included in the received profile information.

The connection management unit 912 may establish the communication link between the digital TV receiver and the mobile device, for example, by storing pairing information. The key management unit 913 may perform various key management functions, for example generating a new key and storing a current session key. The key management unit 913 may also perform encryption, or alternatively a separate encryption unit could be provided.

The service list management unit 914 may perform various functions to manage service lists in the DTV 910. For example, the service list management unit 914 may be arranged to request a service list from a server via the transmitting unit 915b, as described above with reference to FIG. 4. The tuner 917 may be used to validate the received service list.

The mobile device 920 of FIG. 9 includes apparatus comprising a profile information generator 921, a connection management unit 922, a key management unit 923, an authentication unit 924, a network interface 925, an NFC receiver 926, and an application management unit 927.

The network interface 925 includes a receiving unit 925b arranged to receive the profile information request including the authentication code, and further includes a transmitting unit 925a arranged to transmit the profile information to the DTV 910. The authentication unit 924 is arranged to use the received authentication code to authenticate the DTV 910, as described above with reference to FIG. 6.

The profile information generator 921 is arranged to retrieve profile settings of the mobile device 920, and generate profile information including the profile settings. The mobile device 920 may generate and transmit the profile information using any of the methods disclosed herein. The connection management unit 922 and key management unit 923 may perform similar functions to the corresponding units 912, 913 in the DTV 910.

The application management unit 927 is used to manage applications installed on the mobile device 920, using any of the methods disclosed herein. In an embodiment, the application management unit 927 is arranged to receive service identification information identifying one or more services receivable by the DTV 910. The application management unit 927 may then download and install the application.

The network interfaces 915, 925 in FIG. 9 each include a receiver unit 915a, 925b, and a transmitter unit 915b, 925a, to enable bidirectional communication over a network. Although in an embodiment the profile information and the request are sent over a network interface, in other embodiments any suitable interface may be used, as has already been described above. For example, in another embodiment the respective transmitter and receiver units in the DTV and mobile device may communicate over a USB interface.

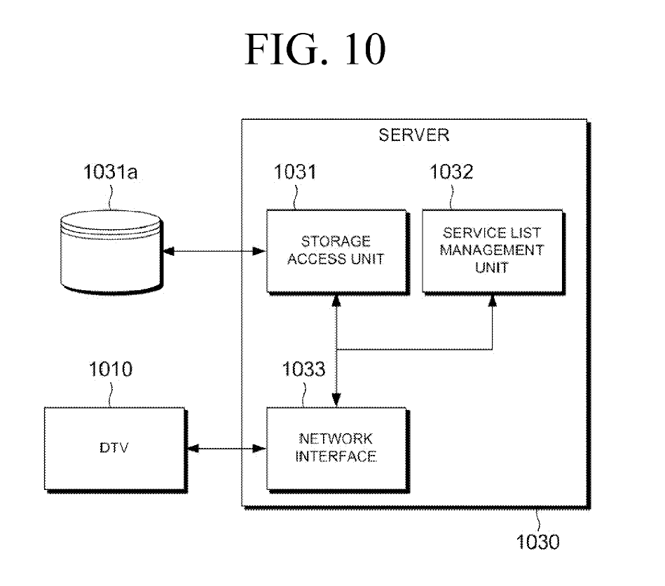

Referring now to FIG. 10, a service list server to provide service lists to digital TV receivers is illustrated, according to an embodiment of the disclosure. The server 1030 comprises a storage access unit 1031, a service list management unit 1032, and a network interface 1033.

The storage access unit 1031 is arranged to access a plurality of service lists stored in a storage unit 1031a, which may be local or remote to the server 1030. For example, the storage unit 1031a may be cloud storage, or may be a local hard disk drive. The network interface 1033 may communicate with a digital TV receiver 1010, such as the DTV illustrated in FIG. 9. The service list management unit 1032 may perform various service list management functions, as described above with reference to FIGS. 4 and 5.

Various methods have been described herein with reference to the drawings. It should be understood that the disclosed methods are not exclusive, and in an embodiment of the disclosure, any of the methods may be implemented alone or in combination with any of the other methods.

While certain embodiments of the disclosure have been described herein with reference to the drawings, it will be understood that many variations and modifications will be possible without departing from the scope of the disclosure as defined in the accompanying claims.

1-16. (canceled)

18-27. (canceled)

29-54. (canceled)

55. A method of configuring one of a digital Television (TV) receiver and a mobile device, the method comprising:
receiving profile information from one of the digital TV receiver and the mobile device; and
configuring other one of the digital TV receiver and the mobile device based on the received profile information from the one of the digital TV and the mobile device.

56. The method of claim 55, wherein the profile information includes one or more profile settings and the configuring is performed based on the one or more profile settings.

57. The method of claim 55, wherein the profile information is related to at least one of a user profile or a device profile of the digital TV receiver or the mobile device.

58. The method of claim 55, further comprising:
establishing a communication link between the digital TV receiver and the mobile device; and
exchanging an encryption key between the digital TV receiver and the mobile device over the communication link,
wherein the profile information is encrypted by the encryption key.

59. The method of claim 58, wherein the communication link is a near-field communication (NFC) link.

60. The method of claim 59, wherein after exchanging the encryption key over the NFC link, the encrypted profile information is received via a different communication link.

61. The method of claim 55, wherein the profile information is received during an installation procedure of the other one of the digital TV receiver and the mobile device, and the method further comprises:
transmitting a message from the other one of the digital TV receiver and the mobile device to the one of the digital TV receiver and the mobile device, to trigger an event relating to the installation procedure at the one of the digital TV receiver and the mobile device.

62. The method of claim 61, wherein the event relating to the installation procedure comprises:
reproducing an audio and/or video clip relating to the installation procedure, at the one of the digital TV receiver and the mobile device.

63. The method of claim 55, wherein method further comprises:
transmitting a signal from the other one of the digital TV receiver and the mobile device to request the profile information, the signal including an authentication code to identify the other one of the digital TV receiver and the mobile device.

64. The method of claim 55, wherein the digital TV receiver receives the profile information from the mobile device, and wherein the received profile information includes location information relating to a location of the mobile device, and configuring the digital TV receiver comprises setting a current location of the digital TV receiver according to the location information.

65. The method of claim 55, further comprising:
transmitting a request for a service list to a server, the service list comprising a list of services expected to be receivable by a receiver in one of a plurality of receiver groups; and
receiving the service list from the server,
wherein the request includes information identifying one of a current location of the digital TV receiver, a reception medium through which the digital TV receiver is configured to receive services, and a service provider from which the digital TV receiver is configured to receive services.

66. The method of claim 65, further comprising:
selecting one or more services from the received service list;
tuning, for each selected service, to an expected frequency of the selected service to determine whether the selected service is receivable at the expected frequency; and
storing the received service list at the digital TV receiver in response to a determination that the selected one or more services are receivable at the expected frequencies.

67. The method of claim 55, further comprising:
transmitting, to a server, information about services receivable by the digital TV receiver, and information identifying one of a current location of the digital TV receiver, a reception medium through which the digital TV receiver is configured to receive services, and a service provider from which the digital TV receiver is configured to receive services.

68. The method of claim 56, wherein the profile settings includes one or more of: a current location; a country setting; a language setting; network configuration settings;
accessibility settings; a list of installed applications; a list of favorite websites; and user account settings.

69. The method of claim 55, wherein the mobile device is a mobile telephone, a tablet computer, a laptop computer, digital camera or wearable device.

70. A method of providing profile settings to one of a digital TV receiver and a mobile device, the method comprising:
retrieving one or more profile settings of one of the digital TV receiver and the mobile device;
generating profile information including the one or more retrieved profile settings; and
transmitting the profile information to the one of the digital TV receiver and the mobile device.

71. The method of claim 70, further comprising:
establishing a communication link between the digital TV receiver and the mobile device; and
exchanging an encryption key between the digital TV receiver and the mobile device over the communication link,
wherein the profile information is protected using the encryption key.

72. The method of claim 71, wherein the communication link is a near-field communication (NFC) link.

73. The method of claim 71, wherein after exchanging the encryption key over the NFC link, the encrypted profile information is transmitted via a different communication link.

74. The method of claim 70, wherein the profile information is transmitted during an installation procedure of the one of the digital TV receiver and the mobile device, and the method further comprises:
receiving a message from the one of the digital TV receiver and the mobile device to other one of the digital TV receiver and the mobile device, to trigger an event relating to the installation procedure at the other one of the digital TV receiver and the mobile device.

75. The method of claim 74, wherein the event relating to the installation procedure comprises:
reproducing an audio and/or video clip relating to the installation procedure, at the other one of the digital TV receiver and the mobile device.

76. The method of claim 70, further comprising:
receiving a signal from the one of the digital TV receiver and the mobile device, the signal including an authentication code to identify the one of the digital TV receiver and the mobile device; and
authenticating the one of the digital TV receiver and the mobile device using the authentication code,
wherein the profile information is only transmitted if the authentication is successful.

77. The method of claim 70, further comprising:
receiving service identification information from the digital TV receiver, at the mobile device, the service identification information identifying one or more services receivable by the digital TV receiver;
obtaining an application corresponding to a service identified by the service identification information, at the mobile device; and
installing the obtained application at the mobile device.

78. The method of claim 77, wherein obtaining of the application corresponding to the service comprises:
searching among a plurality of applications each associated with at least one of an application name, package name, and website; and
obtaining one of the plurality of applications associated with the matched application name, package name, or website in response to a match between the service identification information and one of the application names, package names, or websites.

79. A control method of a server configured to access a plurality of stored service lists corresponding to a plurality of receiver groups, each service list comprising a list of services expected to be receivable by a receiver in one of the plurality of receiver groups, the method comprising:
receiving information about services receivable by a digital TV receiver, and information identifying one of a current location of the digital TV receiver, a reception medium through which the digital TV receiver is configured to receive services, and a service provider from which the digital TV receiver is configured to receive services;
determining which one of the plurality of receiver groups the digital TV receiver belongs to, based on the information received from the digital TV receiver; and
updating the stored service list for the receiver group to which the digital TV receiver belongs, based on the information about the services receivable by the digital TV receiver.

80. A computer-readable storage medium storing a computer program instruction which, when executed by one or more processors, cause the one or more processors to perform the method of claim 55.

81. Apparatus to configure one of a digital TV receiver and a mobile device, the apparatus comprising:
a receiving unit arranged to receive profile information from one of the digital TV receiver and the mobile device; and
a configuration setting unit arranged to configure other one of the digital TV receiver and the mobile device based on the received profile information from one of the digital TV receiver and the mobile device.

82. The apparatus of claim 81, wherein the profile information includes one or more profile settings and the configuring is performed based on the one or more profile settings.

83. The apparatus of claim 81, wherein the one or more profile settings are related to at least one of a user profile or a device profile of the digital TV receiver or the mobile device.

84. The apparatus of claim 81, further comprising:
a connection management unit arranged to establish a communication link between the digital TV receiver and the mobile device; and
a key management unit arranged to exchange an encryption key between the digital TV receiver and the mobile device over the communication link,
wherein the profile information is protected using the encryption key.

85. The apparatus of claim 84, wherein the communication link is a near-field communication (NFC) link.

86. The apparatus of claim 85, wherein after the encryption key is exchanged over the NFC link, the receiving unit is arranged to receive the encrypted profile information is received via a different communication link.

87. The apparatus of claim 81, wherein the profile information is received during an installation procedure of the other one of the digital TV receiver and the mobile device, and the apparatus further comprises:
a transmitting unit arranged to transmit a message from the one of the digital TV receiver and the mobile device to the other one of the digital TV receiver and the mobile device, to trigger an event relating to the installation procedure at the other one of the digital TV receiver and the mobile device.

88. The apparatus of claim 87, wherein the event relating to the installation procedure comprises:
reproducing an audio and/or video clip relating to the installation procedure, at the other one of the digital TV receiver and the mobile device.

89. The apparatus of claim 81, further comprising:
a transmitting unit arranged to transmit a signal from the one of the digital TV receiver and the mobile device to request the profile information, the signal including an authentication code to identify the one of the digital TV receiver and the mobile device.

90. The apparatus of claim 81, wherein the configuration setting unit is arranged to configure the digital TV receiver and the receiving unit is arranged to receive the profile information from the mobile device, and
wherein the received profile information includes location information relating to a location of the mobile device, and the configuration setting unit is arranged to set a current location of the digital TV receiver according to the location information.

91. The apparatus of claim 81, further comprising:
a service list management unit arranged to transmit a request for a service list to a server and receive the service list from the server, the service list comprising a list of services expected to be receivable by a receiver in one of a plurality of receiver groups,
wherein the request includes information identifying a current location of the digital TV receiver, and/or a reception medium through which the digital TV receiver is configured to receive services, and/or a service provider from which the digital TV receiver is configured to receive services.

92. The apparatus of claim 91, further comprising:
a tuner to tune to a frequency to receive a service,
wherein the service list management unit is further arranged to selecting one or more services from the received service list, and for each selected service, control the tuner to tune to an expected frequency of the selected service to determine whether the selected service is receivable at the expected frequency, and
wherein the service list management unit is further arranged to store the received service list at the digital TV receiver, in response to a determination that the selected one or more services are receivable at the expected frequencies.

93. The apparatus of claim 81, further comprising:
a transmitting unit arranged to transmit, to a server, information about services receivable by the digital TV receiver, and information identifying a current location of the digital TV receiver, and/or a reception medium through which the digital TV receiver is configured to receive services, and/or a service provider from which the digital TV receiver is configured to receive services.

94. The apparatus of claim 81, wherein the profile settings includes one or more of: a current location; a country setting; a language setting; network configuration settings; accessibility settings; a list of installed applications; a list of favorite websites; and user account settings.

95. The apparatus of claim 81, wherein the mobile device is a mobile telephone, a tablet computer, a laptop computer, digital camera or wearable device.

96. Apparatus to provide profile settings to one of a digital TV receiver and a mobile device, the apparatus comprising:
a profile information generator arranged to retrieve one or more profile settings of one of the digital TV receiver and the mobile device, and generate profile information including the one or more retrieved profile settings; and
a transmitting unit arranged to transmit the profile information to the one of the digital TV receiver and the mobile device.

97. The method of claim 96, wherein the one or more profile settings are related to at least one of a user profile or a device profile of the digital TV receiver or the mobile device.

98. The apparatus of claim 96, further comprising:
a connection management unit arranged to establish a communication link between the digital TV receiver and the mobile device; and
a key management unit arranged to exchange an encryption key between the digital TV receiver and the mobile device over the communication link,
wherein the profile information is protected using the encryption key.

99. The apparatus of claim 98, wherein the link management unit is arranged to establish a near-field communication NFC link.

100. The apparatus of claim 99, wherein after the encryption key is exchanged over the NFC link, the transmitting unit is arranged to transmit the encrypted profile information via a different communication link.

101. The apparatus of claim 96, wherein the profile information is transmitted during an installation procedure of the one of the digital TV receiver and the mobile device, and the apparatus further comprises:
a receiving unit arranged to receive a message from the one of the digital TV receiver and the mobile device to other one of the digital TV receiver and the mobile device, to trigger an event relating to the installation procedure at the other one of the digital TV receiver and the mobile device.

102. The apparatus of claim 101, wherein the event relating to the installation procedure comprises:
reproducing an audio and/or video clip relating to the installation procedure, at the other one of the digital TV receiver and the mobile device.

103. The apparatus of claim 96, further comprising:
a receiving unit arranged to receive a signal from the one of the digital TV receiver and the mobile device, the signal including an authentication code for identifying the one of the digital TV receiver and the mobile device; and
an authentication unit arranged to authenticate the one of the digital TV receiver and the mobile device using the authentication code,
wherein the apparatus is arranged to only transmit the profile information if the authentication is successful.

104. The apparatus of claim 81, further comprising:
an application management unit arranged to receive service identification information from the digital TV receiver, the service identification information identifying a service receivable by the digital TV receiver, obtain an application corresponding to the service identified by the service identification information, and install the obtained application.

105. The apparatus of claim 104, wherein the application management unit is arranged to obtain the application corresponding to the service by searching among a plurality of applications each associated with at least one of an application name, package name, and website, and in response to a match between the service identification information and one of the application names, package names, or websites, obtain one of the plurality of applications associated with the matched application name, package name, or website.

106. A server comprising:
a storage access unit arranged to access a plurality of stored service lists corresponding to a plurality of receiver groups, each service list comprising a list of services expected to be receivable by a receiver in one of the plurality of receiver groups;
a network interface to communicate with a digital TV receiver, the server being arranged to receive, via the network interface, information about services receivable by the digital TV receiver and information identifying a current location of the digital TV receiver, and/or a reception medium through which the digital TV receiver is configured to receive services, and/or a service provider from which the digital TV receiver is configured to receive services; and
a service list management unit arranged to determine which one of the plurality of receiver groups the digital TV receiver belongs to, based on the information received from the digital TV receiver, and to control the storage access unit to update the stored service list for the receiver group to which the digital TV receiver belongs, based on the information about the services receivable by the digital TV receiver.
